(19) United States
(12) Patent Application Publication
(10) Pub. No.: US 2005/0119018 A1
(43) Pub. Date: Jun. 2, 2005

(54) System and method for transmitting data via a mobile communication terminal

(75) Inventor: Yong-Sik Kim, Gyeonggi-Do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/897,933

(22) Filed: Jul. 23, 2004

(30) Foreign Application Priority Data
Nov. 27, 2003 (KR) 85243/2003

(51) Int. Cl. H04Q 7/20

(52) U.S. Cl. 455/466; 455/556.1

(57) ABSTRACT

Disclosed is a system and method for transmitting documents via a mobile communication terminal. The mobile communication terminal includes an integrated camera which captures an image of a document. The image is transmitted by the terminal to a long message service center as a multimedia message service message. The message is transmitted to a commercial server, which uses a character recognition function to detect characters within the image in the message. The detected characters are converted to text and are transmitted to the long service message center, which converts the text to a long message service message. The long message service message is then transmitted to a receiving terminal.

### CROSS-REFERENCE TO RELATED APPLICATIONS

Pursuant to 35 U.S.C. § 119(a), this application claims the benefit of earlier filing date and right of priority to the Korean Patent Application No. 2003-85243, filed on Nov. 27, 2003, the content of which is hereby incorporated by reference in its entirety.

### BACKGROUND OF THE INVENTION

1. Field of the Invention

The present invention relates to a system and method for communicating via a mobile communication terminal, and, more particularly, to a system and method for transmitting data via a mobile communication terminal.

2. Description of Related Art

As mobile communication service and manufacturing technology improve, a user of a mobile communication terminal can now download music or visual media and be able to listen and/or watch at his convenience. Furthermore, photographs may now be taken by cameras mounted on the mobile communication terminals and be transmitted to other mobile communication terminals. Although, mobile communication service providers have increased the number of functions and features associated with their services, there are several constraints in utilizing these functions and features.

An example of such a constraint is the transfer of data to individuals. For example, an individual may wish to transmit data in order to inform another individual a distance away of an interesting article in a newspaper or book. Previously, conventional methods of quickly transmitting data such as an article would be to fax the article or to scan the article with a scanner and creating a picture or text file on a computer and to electronically mail the file to the desired persons. However, if the sender does not have immediate access to a fax machine or scanner and a computer, this method is not likely possible to send the article within a short period of time. Furthermore, if the article is in a book, the pages containing the article may need to be separated.

With the advent of mobile communication terminals with cameras mounted thereon, the article may be photographed and transmitted as data to the recipient's mobile terminal. However, since the clarity and resolution of such cameras are low and the display units of the terminals are small, the contents would not be sufficiently detailed or legible, especially for documents that are lengthier, large type font, and unclear text. The only alternative available to the sender would be to retype the article as a short message and submit the article as a Short Message Service (SMS) transmission.

### SUMMARY OF THE INVENTION

Accordingly, the present invention is directed to a system and method for transmitting data via a mobile communication terminal that substantially obviates one or more problems due to limitations and disadvantages of the related art above.

In accordance with one aspect of the invention, a system is provided for transmitting data via a mobile communication terminal with an integrated photographic apparatus, a multimedia message service (MMS) function, and a long message service center (LMSC).

In accordance with another aspect of the invention, there is provided a method for transmitting data via a mobile communication terminal using an integrated photographic apparatus, a multimedia message service (MMS) function, and a long message service center (LMSC).

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a mobile communication terminal comprising: a photographic apparatus to photograph a document, wherein the mobile communication terminal transmits the photographed document to a server, wherein the server converts the photographed document to text and transmits the text to a destination. A receiving terminal may receive the transmitted text from the server and the receiving terminal may comprise a mobile communication terminal.

According to an aspect of the present invention, the image may be transmitted by the mobile communication terminal as a multimedia message service message. The image may also be converted by the server to text using a character recognition function to detect text characters within the image.

According to another aspect of the present invention, the server comprises a long message service center and a commercial server. The commercial server may transmit the text to the long message service center. Also, the long message service center may convert the transmitted data to a long message service message and transmits the long message service message to the receiving terminal.

According to another aspect of the present invention, a system for transmitting data captured by a photographic apparatus is provided, wherein the system comprises: a long message service center (LMSC) to receive an image of a document captured by the photographic apparatus, the image being transmitted by a mobile communication terminal as multimedia message service (MMS) message; and a server to receive the MMS message from the LMSC to convert the image to text using a character recognition function and to transmit the text to LMSC, wherein the LMSC converts the text to a long message service (LMS) message and forwards the LMS message to a receiving terminal.

It is to be understood that both the foregoing general description and the following detailed description are exemplary and explanatory and are intended to further describe the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention. In the drawings:

FIG. 1 illustrates a block diagram of a system for transmitting data via a mobile communication terminal with an integrated photographic apparatus according to a one embodiment of the invention.

FIG. 2 illustrates an exemplary diagram of the conversion process of a data according to one embodiment of the invention.

FIG. 3 illustrates a flowchart of a method for transmitting data via a mobile communication terminal according to one embodiment of the invention.

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

Reference will now be made in detail to one or more embodiments of the invention, examples of which are illustrated in the accompanying drawings.

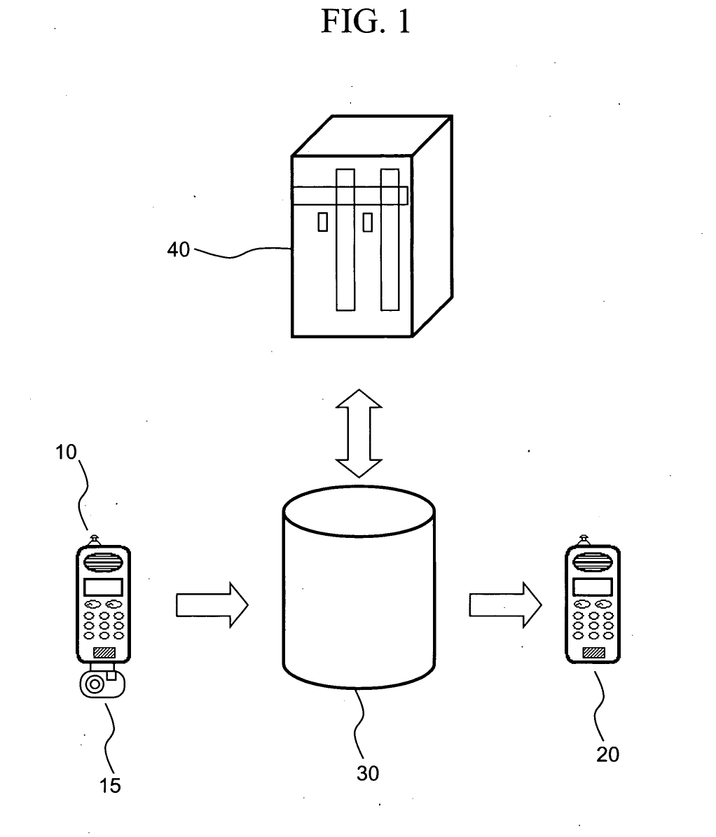

Referring to FIG. 1, a system for transmitting data via a mobile communication terminal, in accordance with an embodiment of the present invention, is illustrated where, for example, the recipient is another mobile communication terminal. Alternatively, the recipient may include desktop and portable computers. In FIG. 1, a mobile communication terminal 10 is shown with an integrated photographic apparatus 15. After having photographed a document, for example, the user of the terminal 10 transmits the photographic data or image data to a long message service center (LMSC) 30, which transmits the data incorporating the image to, for example, a commercial server 40. The commercial server 5 processes the image and transmits the processed data to the LMSC 30. The LMSC 30 then transmits the processed data to the recipient 20, shown here as another mobile communication terminal. The recipient 20 may also comprise the transmitting terminal 10 (i.e., the transmitting terminal sends and receives the processed photographic or image data).

The user utilizes a multimedia message service (MMS) to transmit the data incorporating the image as a MMS message. The LMSC is a long message service (LMS) system in which a MMS message having a large amount of data, such as a photograph or audio file, cannot be transmitted via a SMS or requires a system having greater bandwidth. Accordingly, the LMSC 30 receives the MMS message and transmits the data to the server 40. The server 40 utilizes a character or text recognition function to recognize and read text in the image, convert the data to a text format, and transmit the formatted text to the LMSC 30. The recipient terminal 20 receives the text data as an LMS from the LMSC 30. Where the recipient terminal 20 is also the transmitting terminal 10, as described above, a user may utilize the character or text recognition function to clean or modify image or text data in order to make the image or text more legible, for example.

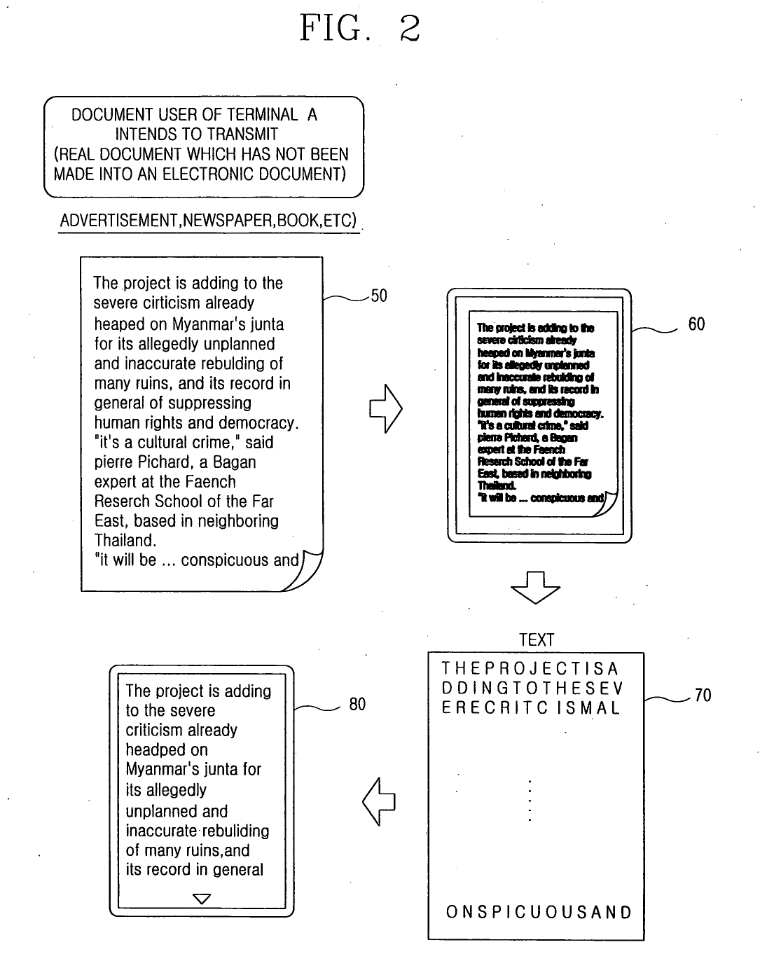

In FIG. 2, a hard document, exemplified here as a newspaper article 50, is to be photographed by a mobile communication terminal with an integrated photographic apparatus, such as the terminal 10 in FIG. 1. In photographing the article 50, an image 60 of the article is reproduced on the terminal's display unit. The lack of clarity and resolution in the image 60 can be seen when compared to the article 50. The user of the terminal submits an MMS message containing the image to another individual having a mobile communication terminal, such as terminal 20 in FIG. 1, or a personal computer. Prior to the recipient receiving the MMS message, the MMS message is transmitted to an LMSC, which transmits the MMS message data to a server for processing. The server utilizes a character recognition function to recognize and read text in the image, convert the data to a text format. The converted text 70 in FIG. 2 is transmitted to the LMSC, which produces a LMS message incorporating the converted text 70. The LMS message appears on the recipient terminal's display unit 80, wherein the text of the article 50 is legibly displayed. Accordingly, shortcomings and constraints presented by the low resolution photographic apparatus, relatively shorter bandwidths for mobile communication, and smaller display units are overcome by the present invention.

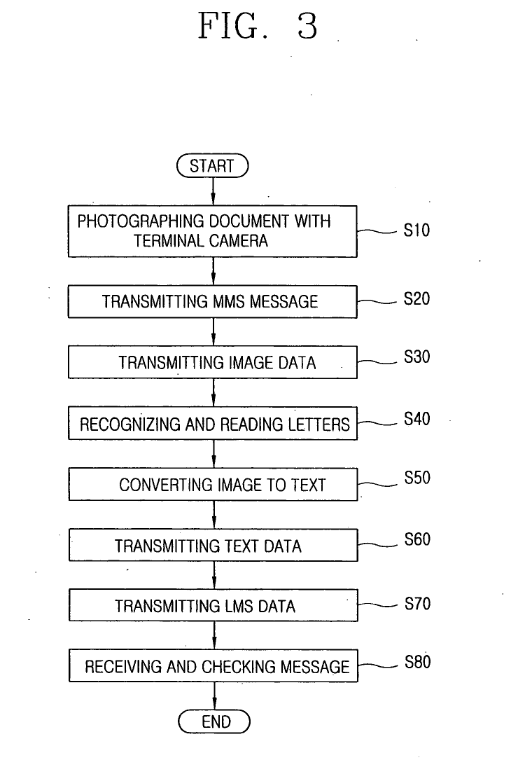

Referring to FIG. 3, a flowchart illustrating the method of transmitting data according to the preferred embodiment of the present invention is shown. A document, for example, is photographed with a mobile communication terminal preferably equipped with an integrated photographic apparatus (S10). The photographic image is transmitted as an MMS message (S20) to a LMSC. The LMSC transmits the image data (S30) to a commercial server. The server performs the function of recognizing and reading (S40) the transmitted image data as text characters. The server converts the image data to text data (S50). The server transmits the text data to the LMSC (S60), which converts the text data to a LMS message. The LMSC then transmits the LMS message to the recipient terminal (S70). The legible LMS message is received and checked by the recipient terminal user (S80).

The preferred embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc.

The logic implementation shown in the figures described specific operations as occurring in a particular order. In alternative implementations, certain of the logic operations may be performed in a different order, modified or removed and still implement preferred embodiments of the present invention. Moreover, steps may be added to the above described logic and still conform to implementations of the invention.

It will be apparent to those skilled in the art that various modifications and variations can be made in the present invention without departing from the spirit or scope of the invention. Therefore, the foregoing description of these embodiments of the present invention has been presented for the purposes of illustration and description. It is not intended to be exhaustive or to limit the invention to the precise form disclosed. Thus, it is intended that the present invention cover the modifications and variations of this invention provided they come within the scope of the appended claims and their equivalents. Preferred embodiments were shown in the context of receiving terminals in the form of mobile communication terminals. In alternative embodiments, desktop and portable computers, PDA terminals, and pagers can be substituted for the mobile communication terminals disclosed as applicable to the present invention.

1. A mobile communication terminal comprising:
a photographic apparatus to photograph a document, wherein the mobile communication terminal transmits the photographed document to a server, wherein the server converts the photographed document to text and transmits the text to a destination.

2. The mobile communication terminal of claim 1, wherein a receiving terminal receives the transmitted text from the server.

3. The mobile communication terminal of claim 2, wherein the receiving terminal is a mobile communication terminal having a display to reproduce the transmitted text.

4. The mobile communication terminal of claim 1, wherein the photographed document is transmitted by the mobile communication terminal as a multimedia message service (MMS) message.

5. The mobile communication terminal of claim 1, wherein the photographed document is converted by the server to text using a character recognition function for detecting text characters within the image.

6. The mobile communication terminal of claim 1, wherein the server comprises a long message service (LMS) center and a commercial server.

7. The mobile communication terminal of claim 6, wherein the commercial server transmits the text to the long message service (LMS) center.

8. The mobile communication terminal of claim 7, wherein long message service (LMS) center converts the transmitted text to a LMS message and transmits the LMS message to a receiving terminal.

9. A system for transmitting data captured by a photographic apparatus, the system comprising:
a long message service center (LMSC) to receive an image of a document captured by the photographic apparatus, the image being transmitted by a mobile communication terminal as multimedia message service (MMS) message; and
a server to receive the MMS message from the LMSC to convert the image to text using a character recognition function and to transmit the text to LMSC, wherein the LMSC converts the text to a long message service (LMS) message and forwards the LMS message to a receiving terminal.

10. The system of claim 9, wherein the receiving terminal comprises a mobile communication terminal.

11. The system of claim 9, wherein the receiving terminal comprises a personal computer.

12. A mobile communication terminal with an integrated photographic apparatus comprising:
means for photographing a document with the integrated photographic apparatus to produce a photograph; and
means for transmitting the photograph with the mobile communication terminal to a server, wherein the server receives the photograph, detects one or more characters within the photograph with a character recognition function, converts the characters to text, and transmits the text to a receiving terminal.

13. The mobile communication terminal of claim 12, wherein the photograph is transmitted by the mobile communication terminal as a multimedia message service message.

14. The mobile communication terminal of claim 12, wherein the text is converted to a long message service message.

15. A system for transmitting image data using a mobile communication terminal, the system comprising:
a character recognition function installed on a server, wherein the server receives image data from the mobile communication terminal and sends text data converted by the character recognition function from the image data, wherein the image data is produced with a photographic apparatus installed on the mobile communication terminal.

16. A method for transmitting a photographed document, the method comprising the steps of:
photographing the document with a photographic apparatus installed on a mobile communication terminal;
manipulating the mobile communication terminal to transmit the photographed document as a multimedia message service (MMS) message to a long message service center (LMSC);
transmitting the MMS message to a server;
converting the photographed document to text using a character recognition function installed on the server;
transmitting the text to the LMSC;
converting the text to a long message service (LMS) message; and
forwarding the LMS message to a receiving terminal.
